(19) United States
(12) Patent Application Publication
(10) Pub. No.: US 2009/0320925 A1
(43) Pub. Date: Dec. 31, 2009

(54) ROTOR ELEMENT FOR A SHEAR VALVE WITH SUBTERRANEAN PASSAGE AND METHOD

(75) Inventor: Jon A. Nichols, Forestville, CA (US)

Correspondence Address: Beyer Law Group LLP, P.O. BOX 1687, Cupertino, CA, 95015-1687, US

(73) Assignee: RHEODYNE, LLC, Rohnert Park, CA (US)

(21) Appl. No.: 12/146,264

(22) Filed: Jun. 25, 2008

(51) Int. Cl. F16K 11/02

(52) U.S. Cl. 137/1; 137/625.46; 251/357

(57) ABSTRACT

A shear valve assembly that includes a stator element having a body, a stator face and at least a first stator passage and a second stator passage extending through the stator body. The first passage and the second passage terminate at the stator face at a respective first stator port and a respective second stator port. The valve further includes a rotor element that defines a rotor face configured for fluid-tight contact against the stator face at a rotor/stator interface. The rotor face defines a first rotor port and a spaced second rotor port, and a rotor body thereof defines a first subterranean passage extending fully beneath the plane of the rotor face. One end of the subterranean passage terminates at the first rotor port at the rotor face surface, while an opposite end thereof terminates at the second rotor port at the rotor face. The rotor face and the stator face is rotatable about a rotation axis relative one another between a first position and a second position. In the first position, the first subterranean passage fluidly couples the first stator port and the second stator port with the first rotor port and the second rotor port, enabling fluid flow between the first stator passage, through the first subterranean passage, and the second stator passage. In the second position, the first subterranean passage is fluidly decoupled from at least one of the first stator port and the second stator port, preventing flow therethrough.

### TECHNICAL FIELD

The present invention relates generally to shear valve assemblies, and more specifically, it relates to rotor elements of the shear valve assemblies.

### BACKGROUND ART

Fluid shear valves are typically a class of valves that incorporate minutely small (in the sub millimeter range) internal fluid passages and operate at relatively high speed and often high pressure. Typically, shear valves are capable of rapidly switching fluid streams from channel to channel with as little fluid dispersion as possible. FIGS. 1-3, for example, illustrate a standard 3-way shear valve 19 configuration that includes a flat faced stator element 20 having a stator face 21 containing two or more stator ports (e.g., first, second and third stator ports 22-24) that are fluidly coupled to the external tubing connections. A mating flat-faced rotor element 25 is also provided that includes at least one fluid channel (e.g., channel 26) substantially contained in the plane of the rotor face 27 to enable switching the fluid from stator port to stator port. These two opposed components are mated to one another, in a fluid-tight manner, at a stator/rotor interface. Upon rotation of the rotor element 25 about its rotational axis 28 to a discrete position, and alignment of the rotor fluid channel 26 with the selected stator ports 22-24, a fluid communication bridge is formed therebetween enabling fluid flow.

Two of the most basic flat-faced shear valves are the 3-way and 4-way valve configuration. FIGS. 2 and 3, as mentioned above, illustrate a stator element 20 of the standard 3-way flat-faced shear valve 19 at the stator/rotor interface, wherein the first through third stator fluid ports 22-24 are shown as solid circles, and the rotating partial C-shaped fluid channel 26 of the rotor element 25 is illustrated as by overlaid solid lines. Typically, these 3-way valves offer two position switching (e.g., first stator port 22 to second stator port 23 (FIG. 2) and first stator port 22 to third stator port 24 (FIG. 3)), although a third position (i.e., second stator port 23 to third stator port 24) is possible, but not in the classic 3-way configuration. FIG. 2, for instance, illustrates a first position wherein the rotor fluid channel 26 forms a fluid communication bridge between first stator port 22 and second stator port 23, while in the second position of FIG. 2, the fluid channel 26 a forms fluid communication bridge between first stator port 22 and third stator port 24.

While shear face valves are reliable, efficient, and highly successful, they often have limited switching options due to the relatively small surface area of the rotor face and the path of the fluid channel. For instance, to facilitate bridging communication, the fluid channel width is typically larger than the diameter of the stator ports 22-24. Moreover, to facilitate channel alignment, the rotor fluid channel 26 is centered at the axis 28 of rotation of the rotor element 25, and its general path extends along the circumference of the Circle C_{A} containing the stator ports 22-24. Accordingly, depending upon the arc length of the fluid channel 26, there is relatively little surface area on the rotor face to provided additional switching options (e.g., for any radially extending fluid channels), especially when the rotor face 27 contains even more stator ports. Accordingly, there is a need to provide a rotor element capable of additional functionality without increasing the surface area of its rotor face.

### DISCLOSURE OF INVENTION

The present invention provides a rotor element for a shear valve assembly, the valve assembly of which includes a stator element having a body, a stator face and at least a first stator passage and a second stator passage extending through the stator body. The first passage and the second passage terminate at the stator face at a respective first stator port and a respective second stator port. The rotor element includes a rotor body that defines a rotor face configured for fluid-tight contact against the stator face at a rotor/stator interface. The rotor face defines a first rotor port and a spaced second rotor port, and the rotor body defines a first subterranean passage extending fully beneath the plane of the rotor face. One end of the subterranean passage terminates at the first rotor port at the rotor face surface, while an opposite end thereof terminates at the second rotor port at the rotor face. The rotor face and the stator face is rotatable about a rotation axis relative one another between a first position and a second position. In the first position, the first subterranean passage fluidly couples the first stator port and the second stator port with the first rotor port and the second rotor port, enabling fluid flow between the first stator passage, through the first subterranean passage, and the second stator passage. In the second position, the first subterranean passage is fluidly decoupled from at least one of the first stator port and the second stator port, preventing flow therethrough.

Accordingly, a fluid communication channel is created in the rotor element that only requires two small access ports on the face thereof rather an entire communication channel on its face. This enables ample area on the rotor face to incorporate additional functionality that might not otherwise be available.

In one specific embodiment, the first subterranean passage is contained in a plane intersecting the rotor face surface. The plane containing the first subterranean passage is substantially perpendicular to an interface plane containing the rotor/stator interface.

In another configuration, the first subterranean passage includes a substantially linear first passage component extending into the rotor body from the first rotor port, and a substantially linear second passage component extending into the body from the second rotor port. The first passage component and the second passage component intersect at an apex portion of the first subterranean passage. At least one of the first passage component and the second passage component is angled about 45° relative to the rotor face surface.

In yet another specific embodiment, the rotor face of the rotor element further includes a patterned rotor channel wherein in the second position, at least a portion of the patterned rotor channel is in fluid communication with at least one of the first stator port and the second stator port.

In another aspect of the present invention, a shear valve assembly is provided having a stator element and a rotor element. The stator element includes a stator body, a stator face and at least a first stator passage and a second stator passage extending through the stator body, the first passage and the second passage terminating at the stator face at a respective first stator port and a respective second stator port. The rotor element includes a rotor body defining a rotor face that is configured for fluid-tight contact against the stator face at a rotor/stator interface. The rotor face defines a first rotor port, and a spaced second rotor port. The rotor body further defines a first subterranean passage extending fully beneath the rotor face, and having one end terminating at the first rotor port at the rotor face surface, and an opposite end terminating at the second rotor port at the rotor face. The face and the stator face are mated for rotation about a rotational axis relative one another between a first position and a second position. In the first position, the first subterranean passage fluidly couples the first stator port and the second stator port with the first rotor port and the second rotor port. This enables fluid flow between the first stator passage, through the first subterranean passage, and the second stator passage. In the second position, the first subterranean passage is fluidly decoupled from at least one of the first stator port and the second stator port.

In one specific embodiment, the stator element includes a third stator passage extending through the stator body, and terminating at the stator face at a respective third stator port. The rotor face and the stator face further being rotatable about the rotation axis, relative one another, to a third position. In this position, the first subterranean passage fluidly couples the third stator port and one of the first and second stator port with the first rotor port and the second rotor port. This enables fluid flow between the third stator passage, through the first subterranean passage, and through one of the first and second stator passage.

In yet another configuration, the rotor face further includes a patterned rotor channel wherein in the second position, at least a portion of the patterned rotor channel is in fluid communication with at least two of the first stator port, the second stator port and the third stator port.

In still another specific embodiment, the stator element further includes a fifth stator passage extending through the stator body. This passage terminates at a fifth stator port that is in fluid communication with the patterned rotor channel when in the second position.

Still another specific arrangement provides a stator element that includes a third stator passage extending through the stator body, and terminates at the stator face at a respective third stator port. A fourth stator passage also extends through the stator body, and terminates at the stator face at a respective fourth stator port. The rotor body further defines a third rotor port and a spaced fourth rotor port, and the rotor body defines a second subterranean passage that extends fully beneath the rotor face. One end of the second subterranean passage terminates at the third rotor port at the rotor face surface, and an opposite end thereof terminates at the fourth rotor port at the rotor face. In the first rotor position, mentioned above, the second subterranean passage fluidly couples the third stator port and the fourth stator port with the third rotor port and the fourth rotor port. This enables fluid flow between the third stator passage, through the second subterranean passage, and the fourth stator passage. In the second position, mentioned above, the second subterranean passage is fluidly decoupled from at least one of the third stator port and the fourth stator port.

The rotor face and the stator face are further rotatable about the rotation axis, relative one another, to a third position. In this position, the first subterranean passage fluidly couples the first stator port and the third stator port with the first rotor port and the third rotor port. This enables fluid flow between the first stator passage, through the first subterranean passage, and the third stator passage. Further, in this third position, the second subterranean passage fluidly couples the second stator port and the fourth stator port with the second rotor port and the fourth rotor port. This enables fluid flow between the second stator passage, through the second subterranean passage, and the fourth stator passage.

In still another aspect of the present invention, a method of transferring liquid in a shear valve assembly is provided that includes providing a shear valve assembly having stator element and a rotor element in relative rotational contact with the stator element, the stator element having a body with a stator face. The stator body defines a first stator passage and a second stator passage extending through the stator body. The method further includes rotating the rotor face relative to the stator face about a rotation axis, while maintaining the fluid-tight seal, to a first position. In this configuration, the first rotor port is in fluid communication with the first stator port, and the second rotor port is in fluid communication with the second stator port. The method further includes passing a liquid through the first stator passage, into the first subterranean passage, and out through the second stator passage.

In one specific embodiment, the method includes rotating the rotor face relative to the stator face to a second position wherein the first subterranean passage is fluidly decoupled from the first stator port and the second stator port.

### BRIEF DESCRIPTION OF THE DRAWING

The assembly of the present invention has other objects and features of advantage which will be more readily apparent from the following description of the best mode of carrying out the invention and the appended claims, when taken in conjunction with the accompanying drawing, in which:

FIG. 1 is an exploded top perspective view of a conventional 3-way shear face valve assembly, showing a rotor face of the rotor element and a stator face of the stator element thereof.

FIG. 2 is a top plan view of the stator face of the stator element taken along the stator/rotor interface of the valve assembly of FIG. 1, and illustrating a fluid channel of the rotor face in a first position with the rotor groove of the rotor element overlaid atop the stator face.

FIG. 3 is a top plan view of the stator face, taken along the stator/rotor interface of FIG. 2, and illustrating the fluid channel of the rotor element in a second position.

FIG. 4 is a top plan view of a 3-way shear valve assembly designed in accordance with the present invention, taken along the plane of the line 4-4 in FIG. 5 at the stator/rotor interface, and illustrating a subterranean passage of the rotor element in a first position with the rotor ports of the rotor element overlaid atop the stator face of the stator element.

FIG. 5 is a cross-sectional side elevation view of the stator element and rotor element, taken along the plane of the line 5-5 in FIGS. 4 and 11, and illustrating fluid coupling of the subterranean passage of the rotor element with two stator ports of the stator element.

FIG. 6 is a top plan view of the stator face of the shear valve assembly of FIG. 4, illustrating the rotor element in a second position with the rotor ports dead-end against the stator face.

FIG. 7 is a top plan view of the stator face of the shear valve assembly of FIG. 4, illustrating the rotor element in a third position.

FIGS. 8A and 8B are cross-sectional side elevation views, taken along the plane of the line 5-5 in FIG. 4, and illustrating alternative embodiments of the subterranean passage of the rotor element.

FIG. 9 is a top plan view of an alternative embodiment to the shear valve assembly and rotor element of FIG. 6, in the second position and illustrating a patterned Y-shaped fluid channel providing additional functionality for the shear face valve.

FIG. 10 is a top plan view of an alternative embodiment to the shear valve assembly of FIG. 9, in the second position and illustrating the incorporation of a center drain port in the stator face.

FIG. 11 is a top plan view of an alternative 4-way shear valve assembly, illustrating the incorporation of two subterranean passages in the rotor element, and shown oriented in a first position.

FIG. 12 is a top plan view of the stator face of the shear valve assembly of FIG. 11, illustrating the rotor element in a third position.

FIG. 13 is a top plan view of an alternative embodiment to the shear valve assembly and rotor element of FIG. 11, in a second position and illustrating a patterned cross-shaped fluid channel providing additional functionality for the shear face valve.

FIG. 14 is a top plan view of another alternative embodiment to the shear valve assembly of FIG. 13, in the second position and illustrating the incorporation of a center drain port in the stator face.

FIG. 15A is a top plan view of an alternative 2-way shear valve assembly, shown oriented in a first position.

FIG. 15B is a top plan view of the stator face of the shear valve assembly of FIG. 15A, illustrating the rotor element in a second position.

FIG. 15C is a top plan view of the stator face of the shear valve assembly of FIG. 15A, illustrating the rotor element in a third position.

FIG. 16 is a top plan view of another alternative embodiment to the 3-way shear valve assembly of FIG. 9.

### BEST MODE OF CARRYING OUT THE INVENTION

While the present invention will be described with reference to a few specific embodiments, the description is illustrative of the invention and is not to be construed as limiting the invention. Various modifications to the present invention can be made to the preferred embodiments by those skilled in the art without departing from the true spirit and scope of the invention as defined by the appended claims. It will be noted here that for a better understanding, like components are designated by like reference numerals throughout the various figures.

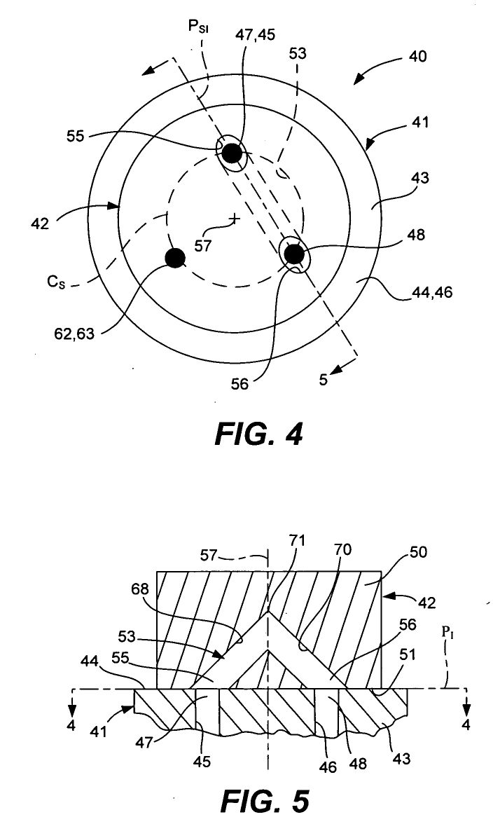

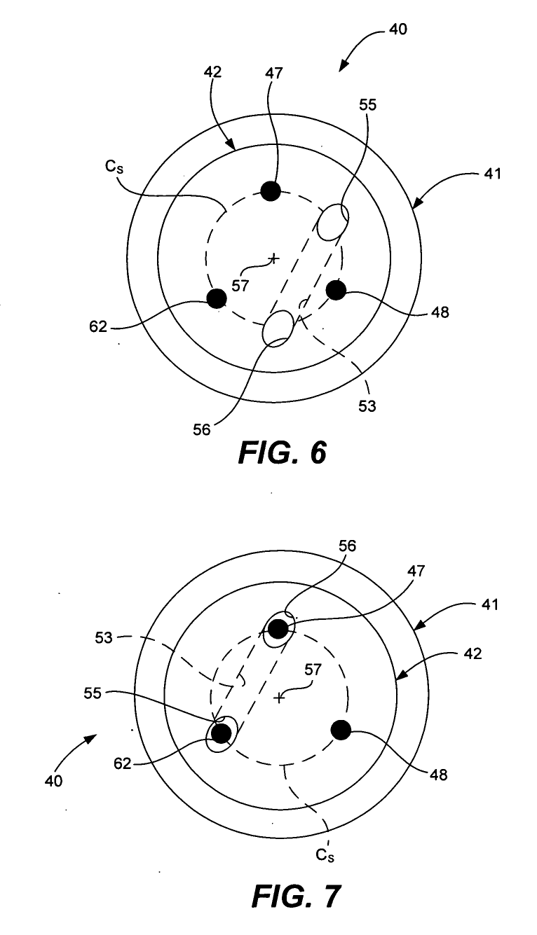

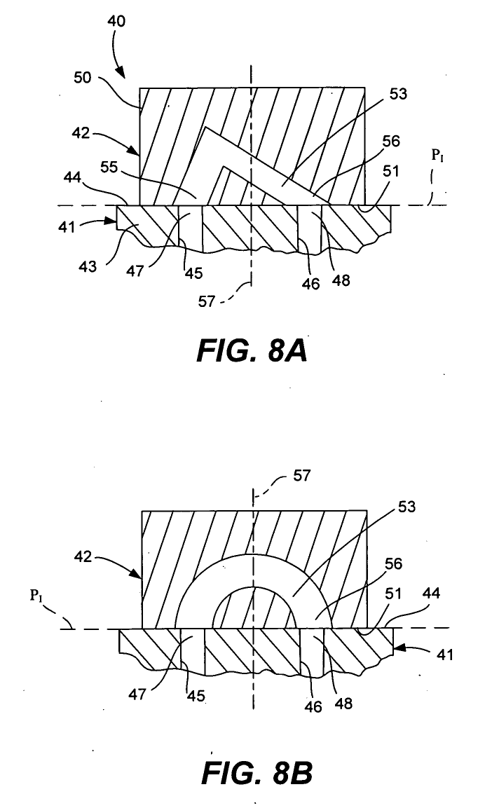

Turning now to FIGS. 4-7, a shear valve assembly, generally designated 40, is provided having a stator element 41 and a rotor element 42 configured for mating engagement with one another. The stator element 41 includes a stator body 43 defining a stator face 44 on one end thereof. The stator body 43 further includes a first stator passage 45 and a second stator passage 46 each extending therethrough, and each having one end terminating at the stator face at a respective first stator port 47 and a respective second stator port 48. The rotor element 42 includes a rotor body 50 defining a rotor face 51 on one end thereof, and disposed in opposed relationship and fluid-tight contact against the stator face 44 at a rotor/stator interface. As best viewed in FIGS. 5, 8A and 8B, the rotor body 50 defines a first subterranean passage 53 extending fully beneath the rotor face 51, and having one end terminating at a first rotor port 55 at the rotor face 51, and an opposite end terminating at a second rotor port 56 at the rotor face. The rotor element 42 and the stator element 41 are cooperatively mated, at a rotor/stator interface, for relative rotation about a longitudinal axis 57 thereof, between a first position (FIG. 4) and a second position (FIG. 6).

Briefly, it will be appreciated that FIGS. 4, 6, 7 and 9-14 illustrate a top plan view of the stator face 44 at the rotor/stator interface, wherein the rotor face 51 is transparently overlaid atop the stator face, and oriented to rotate about the longitudinal axis 57. The stator ports (e.g., first and second stator ports 47, 48) and any additional fluid channels (e.g., patterned fluid channels 58, 60), in these FIGURES, are represented as solid lines, while the subterranean passages (e.g., 53, 61) are represented by broken lines.

Referring back to FIG. 5, in the first position, the first subterranean passage 53 is aligned to fluidly couple or bridge the first stator port 47 and the second stator port 48 of the stator element 41 with the first rotor port 55 and the second rotor port 56 of the rotor element 42. Accordingly, fluid flow is permitted, via the first subterranean passage 53 of the rotor element 42, between the first stator passage 45 and the second stator passage 46 of the stator element 41. In contrast, in the second position of FIG. 6, the first subterranean passage 53 is fluidly decoupled from at least one of the first stator port 47 and the second stator port 48. Further, at least one end (i.e., the first rotor port 55 or the second rotor port 56) of the subterranean passage 53, terminates at a dead-end into the stator face 44 preventing fluid flow therethrough. Similarly, at least one of the first stator port 47 or the second stator port 48 terminates at a dead-end into the rotor face 51 preventing fluid flow therebetween.

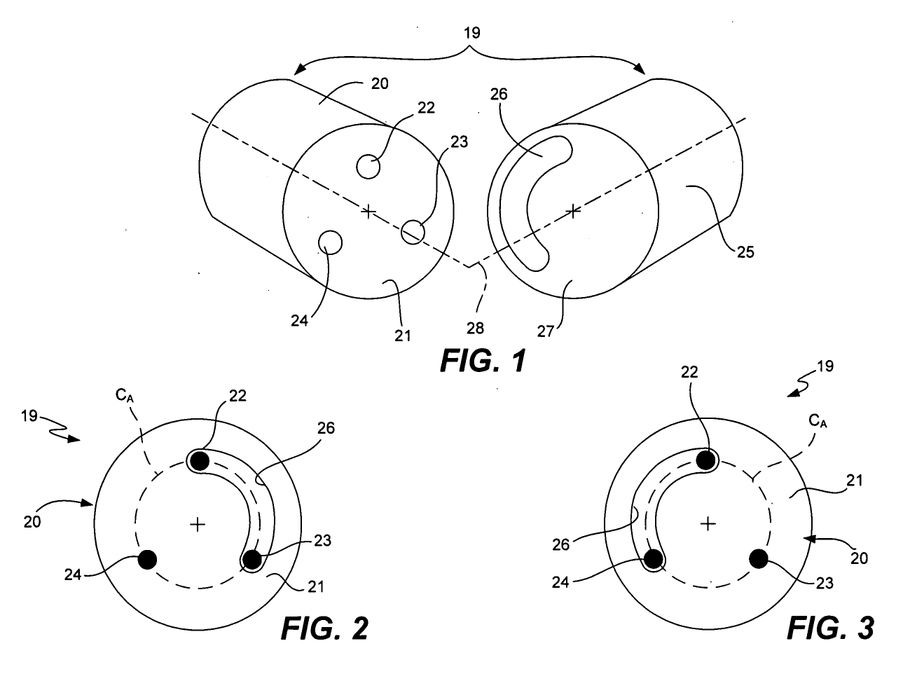

Accordingly, a fluid communication channel or bridge is provided by the rotor element, in the first position (providing the same functionality as the conventional 3-way valve configuration of FIG. 2). Effectively, the fluid switching capabilities of the rotor element 42 utilize all three dimensions, as opposed to just the two dimensions so the rotor face 51. Consequently, the same fluid switching capability of the rotor element can be provided, albeit occupying a significantly smaller surface area of rotor face 51 (i.e., the first rotor port 55 and the second rotor port 56). That is, rather than occupying valuable surface area of the rotor face 51 (e.g., such as with a fluid communication channel 26 in the embodiment of FIGS. 1-3), only two significantly smaller access ports 55, 56 on the rotor face are necessary. The limited surface area of the rotor face, thus, is better optimized, and ample surface area of the rotor face remains to incorporate additional functionality that would not have been available in the rotor face of a conventional rotor element (e.g., the embodiments shown in FIGS. 1-2).

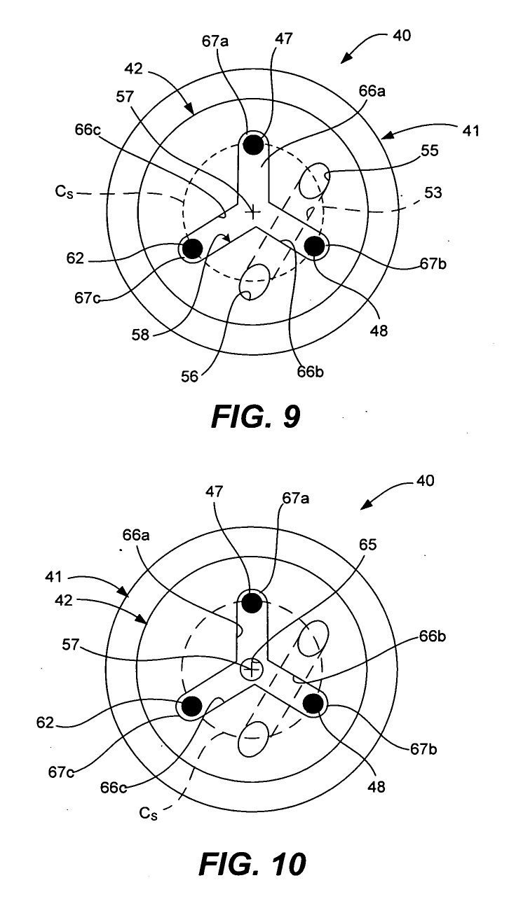

By way of example, the additional functionality may be provided by a Y-shaped patterned fluid channel 58 (FIG. 9) formed into the rotor face 51 of the rotor element 42. In this embodiment, when the rotor element is oriented in the second position, the fluid channel 58 is shaped and dimensioned for simultaneous fluid communication with stator ports 47, 48 and 62.

The added functionality to this 3-way shear valve illustrates the benefits of such subterranean passages in its simplest forms. It will be appreciated that the subterranean passage technology of the present invention, however, can be applied to nearly all conventional shear valve rotor element devices. Thus, more complex valves arrangements can be envisioned, or portions of valves may benefit from this technique, but the 3-way and 4-way designs shown above best illustrate the design procedure.

Briefly, referring generally to FIGS. 4 and 5, the rotor element 42 and the stator element 41 of the shear valve assembly 40 are both generally disk-shaped, and co-axially aligned another along the common longitudinal axis 57 of the shear valve. Common to all shear valve technology, the rotor element is configured to rotate about the longitudinal axis 57 while the stator element is fixed. In one particular embodiment, an opposed side of the rotor element is operably coupled to a motor and drive shaft (both of which are not shown) for selective rotational movement about the longitudinal axis. It will be understood, of course, that any relative movement between the stator element 41 and the rotor element 42 is permissible, however. Moreover, while the interfacing rotor face 51 of the rotor element, and the opposed stator face 44 of the stator element 41, are preferably substantially planar, they need not be as long as the two surfaces sufficiently mesh and mate in a fluid-tight manner while permitting relative rotational movement about the longitudinal between discrete positions.

Referring back to FIGS. 4-7, the stator element 41 of the 3-way shear valve assembly 40 includes first, second and third stator ports 47, 48 and 62. A third stator passage 63 extends through the stator body 43, similar to the first and second stator passage, and terminates at the third stator port 62 on the stator face. As mentioned above, when the valve assembly 40 is oriented in the first position (FIG. 4), the first stator port 47 is fluidly coupled to the second stator port 48, via alignment with the respective first and second rotor ports 55, 56, and subterranean passage 53. The valve assembly 40 can also be selectively oriented in a third position (FIG. 7), fluidly coupling the first stator port 47 to the third stator port 62, via alignment with the respective first and second rotor ports and the subterranean passage.

In accordance with the present invention, the first subterranean passage 53 subtends below the rotor face 51, as best illustrated in the cut-away side view of the rotor element 42 of FIG. 5. In one example, first subterranean passage 53 is preferably contained substantially within in a single plane P_{S1} that intersect a plane P_{I} of the rotor/stator interface. Such parameters simplify the path, as well as reduce the footprint, of the subterranean passage within the rotor body 50, as compared to a subterranean passage snaking back and forth through the rotor body. More preferably, plane P_{S1} is also oriented substantially perpendicular to plane P_{I}, as such a configuration and orientation further simplifies fabrication, while also further reducing any unnecessary path length of the subterranean passage.

In accordance with the present invention, the first subterranean passage 53 consists of two (a first and a second), substantially linear, passage components 68, 70 that both subtend and converge together, forming a generally V-shaped passage. This geometric shape is conducive to fabrication, and can be easily performed by drilling two substantially linear connecting passages, as shown. The first passage component 68 subtends downwardly from the rotor face 51, commencing at the first rotor port 55, while the second passage component 70 also subtends downwardly from the rotor face 51, commencing at the second rotor port 56. These opposed passage components of the first subterranean passage, converge toward one another until they intersect with one another at a bottom apex portion 71 within the rotor body 50. Typically, the depth of the apex portion is no more than about ½ the height of the rotor body.

Each passage component is accordingly sized to accommodate sufficient fluid flow therethrough, and to facilitate port alignment. The diameter of each passage may be slightly oversized relative to the diameter of the stator ports to be aligned therewith, for instance, in the range of about 2.2 mm to about 0.12 mm when the stator ports have a diameter in the range of about 2.0 mm to about 0.10 mm. In fact, the oval shaped rotor ports will be naturally larger in one direction than the stator ports due to the angle of incidence of each passage component with the rotor face.

The angle of intersection between the two passage components 68, 70, at the apex portion 71, and its depth into the rotor body 50 are generally dictated by the angle of incidence of each passage component relative to the plane P_{I} of the rotor/stator interface. Generally, for the ease of fabrication, the angle of incidence of each passage component 68, 70 is substantially equal to one another, and typically in the range of about 60° to about 30°. Consequently, the angle of intersection between the passage components is about a right (90°) or an obtuse angle.

It follows, of course, that the greater (or steeper) the angle of incidence of either the first or second passage component 68, 70, the smaller the angle of the intersection at the apex portion. Moreover, while the angle of incidence of the first and second passage components 68, 70 with the interface plane P_{I} is preferably substantially equal to one another, thus dictating a substantially equal length of each passage component, such equality is not necessary. For example, as shown in FIG. 8A, the angle of incidence of the first subterranean passage component 68 may be steeper than that of the second subterranean passage component 70, essentially offset the passage to one side of the rotor element. This may be beneficial depending upon the addition, and/or layout, of other subterranean passages.

As mentioned, these two substantially linear passage components intersect one another at an apex portion. Such an angular, converging orientation of the passage components is conducive to simple fabrication via the application of conventional drilling techniques oriented at the proper angle of incidence. It will be appreciated, however, that other geometric configurations of the subterranean passages may be implemented. For example, FIG. 8B illustrates a subterranean passage 53 having a curvilinear profile, albeit more difficult to fabricate in a solid rotor. One particular fabrication technique, for example, includes the application of a flexible tube member having the desired inner diameter dimensions. The rotor body then may be molded around the tubing, thus, encapsulating the tube and creating the subterranean passage with a curvilinear profile therein.

The primary benefit of the application of such rotor element subterranean passages, as above indicated, is the capability to provide additional functionality to the shear valve assembly given that the total surface area of the rotor face is identical to that of a conventional 3-way valve assembly design. FIGS. 4 and 6 best illustrate, for instance, that nearly the entire surface area of the rotor face 51 is still available to provide added functionality with the exception of the spaced-apart and generally oval-shaped first and second rotor ports 55, 56.

FIG. 9, in one specific embodiment, illustrates such added functionality for the shear valve assembly, through the implementation of the patterned fluid channel 58 in the rotor element 42. In the second position, this pattered fluid channel 58 is formed and configured to communicably align with the first, second and third stator ports 47, 48 and 62, providing simultaneous fluid communication therebetween. Another specific embodiment, as shown in FIG. 10, is the incorporation of a central drain port 65 in the stator element. In this manner, the drain port 65 can provide a common drain outlet (or supply port) for the first, second and third stator ports 47, 48 and 62, for example. It will be appreciated that while the central drain port 65 is oriented at the center of the stator face, this of course need not be the case as it may be positioned anywhere as long as fluid communication with the patterned fluid channel 58 remains in the second position.

In the specific embodiment illustrated in FIGS. 9 and 10, the patterned fluid channel 58 is generally Y-shaped and cut or formed into the rotor face 51 of the rotor element 42. In its most efficient form, the Y-shaped fluid channel 58 consists of three equal length leg portions 66a-66c that extend radially outward from the center drain port 65, which is also centrally disposed at the longitudinal axis 57 of the valve assembly 40. Each leg portion 66a-66c is radially spaced apart from one another about 120°, about longitudinal axis 57, and each terminates at a respective distal end region 67a-67c. As shown, the distal end regions 67a-67c are oriented along Circle C_{S} that contains the first and second rotor ports 55 and 56 of the subterranean passage 53, as well as the first, second and third stator ports 47, 48 and 62. The channel width of each leg portion is sized and dimensioned to communicably align with the first, second and third stator ports 47, 48 and 62 of the stator face, when the rotor element 42 rotationally oriented in the second position. It will be appreciated that the patterned fluid channel 58 may be comprised of one, two or three legs, legs depending upon the desired fluid switching design.

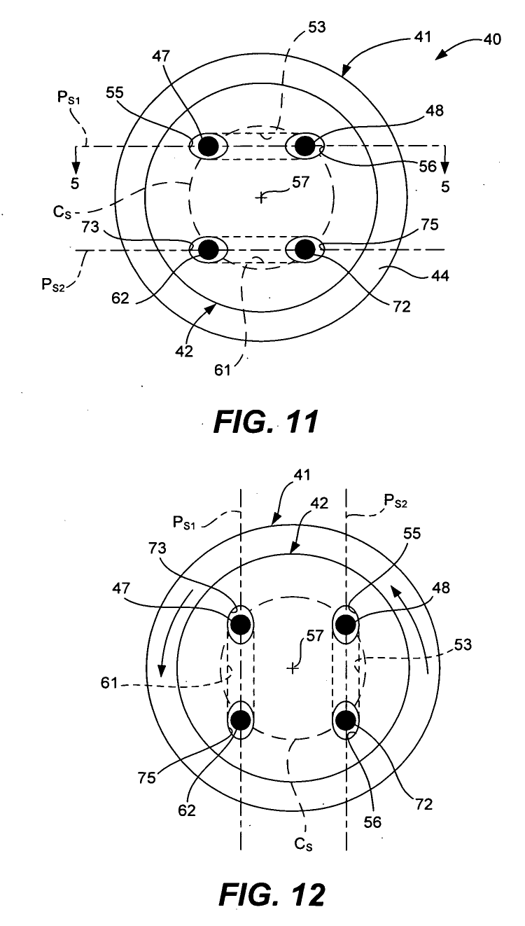

Referring now to FIGS. 11 and 12, another specific embodiment of the rotor element 42 is illustrated that incorporates both a first subterranean passage 53 and an adjacent second subterranean passage 61. This particular configuration is well suited for a 4-way valve application, where channel switching is performed between the first, second, third and a fourth stator port 47, 48, 62 and 72 that are equally spaced-apart radially and oriented along the Circle C_{S}.

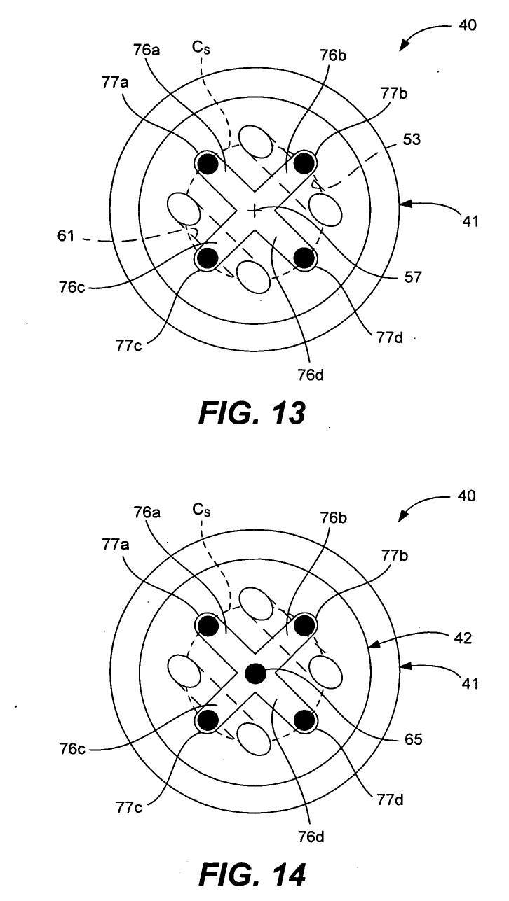

The first subterranean passage 53, as above indicated, includes the first rotor port 55 on one end thereof and the second rotor port 56 on the opposed end thereof. Similarly, the second subterranean passage 61 includes a third rotor port 73 on one end thereof and a fourth rotor port 75 on the opposed end thereof. As best illustrated in FIG. 11, these four rotor ports are equally and symmetrically spaced from one another, and contained generally along the imaginary Circle C_{S}. If follows, of course, that these rotor ports 55, 56, 73 and 75 are aligned and positioned to fluidly communicate with the corresponding first, second, third and fourth stator ports 47, 48, 62 and 72 when oriented in the first position of FIG. 11 and the third position of FIG. 13.

Similar to the 3-way valve embodiment of FIGS. 4-10, when the rotor element 42 and the stator element 41 of the 4-way valve embodiment are relatively rotated about the longitudinal axis 57 to the first position, the first rotor port 55 is communicably aligned with first stator port 47 while the second rotor port 56 is communicably aligned with the second stator port 48. As previously indicated, the first subterranean passage 53 then fluidly couples or bridges the first stator port 47 and the second stator port 48 of the stator element 41 to enable fluid flow therebetween. Similarly, the third rotor port 73 of the second subterranean passage 61 is communicably aligned with third stator port 62 while the fourth rotor port 75 is communicably aligned with the fourth stator port 72. Upon such alignment, the second subterranean passage 61 then fluidly couples or bridges the third stator port 62 and the fourth stator port 72 of the stator element 41 to enable fluid flow therebetween.

Referring now to FIG. 12, the rotor element 42 may be rotated about axis 57, in either a clockwise or counter clockwise direction, relative to the stator element to a third position. If a clockwise rotation orients the rotor element in the third position, by way of example, then the first rotor port 55 of the first subterranean passage 53 is then communicably aligned with second stator port 48 while the second rotor port 56 is communicably aligned with the fourth stator port 72. The first subterranean passage 53 then fluidly couples or bridges the second stator port 48 and the fourth stator port 72 of the stator element 41 to enable fluid flow therebetween. Similarly, the third rotor port 73 of the second subterranean passage 61 is then communicably aligned with first stator port 47 while the fourth rotor port 75 is communicably aligned with the third stator port 62. The second subterranean passage 61 then fluidly couples or bridges the first stator port 47 and the third stator port 62 of the stator element 41 to enable fluid flow therebetween.

Whether the valve assembly 40 is oriented in the first position or the third position, fluid communication channels or bridges are formed, via the subterranean passages that permit fluid flow between the corresponding stator ports 47, 48, 62 and 72. Again, nearly the entire surface area of the rotor face 51 is still available to provide added functionality (with the exception of the spaced-apart and generally oval-shaped first, second, third and fourth rotor ports 55, 56, 73 and 75). Such added functionality, for example and as will be described in greater detail below, may include a patterned fluid channel 60 that similarly enables simultaneously fluid communication between the four stator ports 47, 48, 62 and 72 (FIGS. 13 and 14).

Referring back to FIGS. 11 and 12, the second subterranean passage 61 is preferably disposed adjacent to the first subterranean passage 53. Moreover, both subterranean passages 53, 61 are shown and illustrated as being contained substantially within in corresponding planes P_{S1} and P_{S2} that themselves are oriented substantially parallel one another. Still further, these substantially parallel planes P_{S1} and P_{S2} containing the subterranean passages 53, 61 are oriented substantially perpendicular to the rotor face 51. It will be appreciated of course that the subterranean passages not be contained substantially within a plane, nor if they are, do the planes P_{S1} and P_{S2} need to be substantially parallel to one another, or substantially perpendicular to the rotor face. Also similar to the 3-way valve assembly embodiment, the subterranean passages 53, 61 themselves are preferably V-shaped, having the same geometric and dimensional properties described above.

Referring back to FIGS. 13 and 14, a patterned rotor channel 60 is cut or formed into the rotor face 51 of the rotor element 42, and is sized and dimensioned to communicably align with the first, second, third and fourth stator ports 47, 48, 62 and 72 of the stator face, when the rotor element 42 rotationally oriented in the second position. The rotor channel 60, in this particular configuration, “plus” or “cross” shaped, and consist of four leg portions 76a-76d that extend radially outward from the longitudinal axis 57 of the valve assembly 40. Each leg portion 76a-76d is radially spaced apart from one another about 90°, about axis 57, and each terminates at a respective distal end region 77a-77d. Similar to the previous embodiment, the distal end regions 77a-77d are oriented along Circle C_{S} that contains rotor ports 55, 56, 73 and 75 of the subterranean passages 53, 61, as well as the stator ports 47, 48, 62 and 72. It is also similar to the previous embodiment although some legs may be omitted depending upon the fluid design.

FIG. 14 represents still another embodiment that adds center port 65 in the normally unused center position. Similar to the 3-way valve configuration, use of such a center port 65 could function as a common drain or supply port for the first through fourth stator ports.

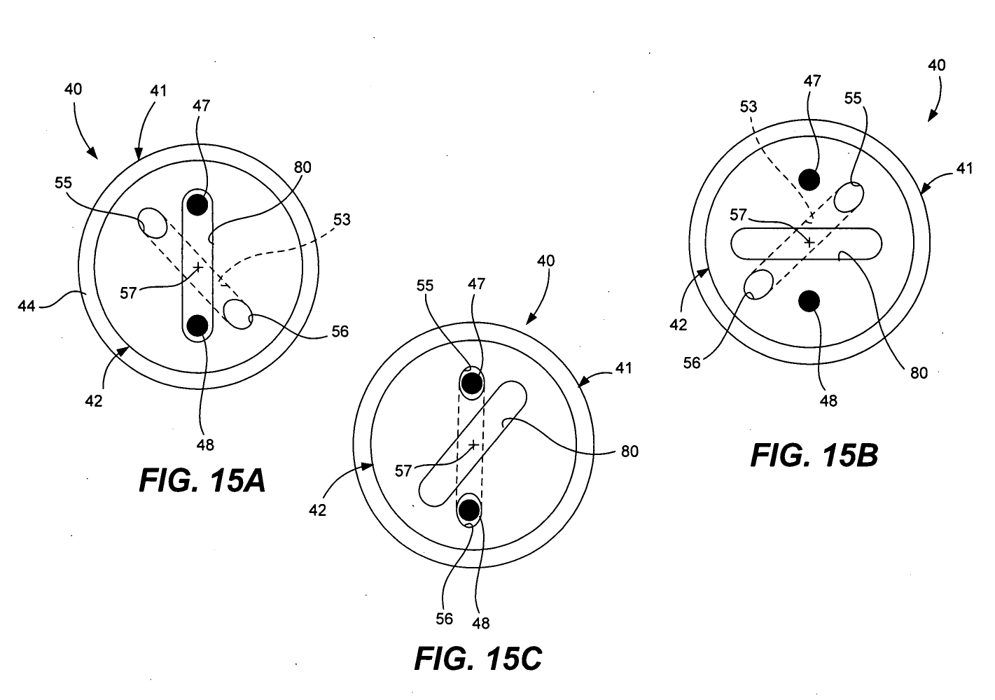

In another specific embodiment, a subterranean passage 53 may be included that provides additional functionality to a simple 2-way valve configuration. For example, as shown in FIGS. 15A-15C, the 2-way shear valve configuration is shown having a first stator port 47 and a second stator port 48. The rotor face 51 of the rotor element 42, overlaid atop the stator face 44, defines a fluid communication channel 80 sized, dimensioned and aligned to fluidly communicate with both the first stator port 47 and the second stator port 48, in the first position (FIG. 15A). Conventionally, this first (or “on”) position forms a fluid communication bridge between the stator port. When the rotor element 42 is rotated about axis 57 to the second (or “closed”) position (FIG. 15B), the fluid communication channel 80 is moved out of fluid communication with the stator ports 47, 48. Fluid flow, accordingly, is halted therebetween.

In accordance with the present invention, a subterranean passage 53 is provided in the rotor element 42 having the first rotor port 55 and the second rotor port 56 out of fluid communication with the stator ports 47, 48 in both the first and second positions of FIGS. 15A and 15B. FIG. 15C, however, illustrates co-alignment of the first rotor port 55 with the first stator port 47, as well as between the second rotor port 56 with the second stator port 48. A fluid bridge is thus created in this third position, in a manner similar to the first rotor position, via the fluid communication channel 80.

The difference, however, is that the capacity of the subterranean passage 53 can be significantly larger than that of the fluid communication channel 80. Accordingly, in one particular application, the added functionality is the ability to apply the larger fixed capacity of the subterranean passage 53 (vs. the capacity of a conventional communication channel 80) to store a portion of the sample stream flow (in the first and second positions (FIGS. 15A and 15B). Subsequently, the rotor element 42 can be moved to the third position of FIG. 15C, and dispensed.

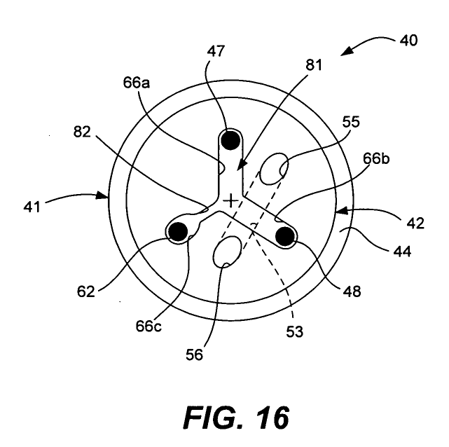

Referring now to FIG. 16, an alternative to the embodiment of FIG. 9 is illustrated having a patterned fluid channel 81 capable of uneven fluid flow. As shown, one leg portion 66c of the patterned fluid channel 81 can be uniformly narrower, or include a narrowed neck portion 82, forming a fluid flow splitter. In this specific embodiment, for instance, the first stator port 47 is configured to input fluid into the patterned channel 81, and both the second stator port 48 and the third stator port 62 are configured to output ports.

The rate of fluid flow through the corresponding third stator port 62, however, is reduced, as compared to the wider or non-restricted leg portion 66b of the channel 81. In one specific example, for instance, the restricted leg portion 66c may be such that 90% of the fluid input through the first stator port 47 is output through the second stator port 48, while the remaining 10% is output through the third stator port 62. It will be understood, of course, that the transverse cross-sectional area of the neck portion 82 can be altered, relative to the transverse cross-sectional area of second leg portion 66b, to adjust the proportional flow therethrough.

It will be appreciated that the forgoing embodiments are only a few illustrations of added functionality that can be applied using the subterranean rotor passages of the present invention. Other configuration fluid channel configurations, therefore, can be easily implemented such. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A rotor element for a shear valve assembly, said valve assembly including a stator element having a body, a stator face and at least a first stator passage and a second stator passage extending through the stator body, said first passage and said second passage terminating at the stator face at a respective first stator port and a respective second stator port, said rotor element comprising:
a rotor body defining a rotor face configured for fluid-tight contact against said stator face at a rotor/stator interface, said rotor face defining a first rotor port and a spaced second rotor port, and said rotor body defining a first subterranean passage extending fully beneath said rotor face having one end terminating at the first rotor port at the rotor face surface, and having an opposite end terminating at the second rotor port at the rotor face, said rotor face and said stator face being rotatable about a rotation axis relative one another between:
a first position wherein said first subterranean passage fluidly couples the first stator port and the second stator port with the first rotor port and the second rotor port, enabling fluid flow between the first stator passage, through the first subterranean passage, and the second stator passage; and
a second position wherein said first subterranean passage is fluidly decoupled from at least one of the first stator port and the second stator port.

2. The rotor element according to claim 1, wherein
said first subterranean passage is contained in a plane intersecting the rotor face surface.

3. The rotor element according to claim 2, wherein
said plane containing the first subterranean passage is substantially perpendicular to an interface plane containing the rotor/stator interface.

4. The rotor element according to claim 2, wherein
said first subterranean passage includes a substantially linear first passage component extending into the rotor body from the first rotor port, and a substantially linear second passage component extending into the body from the second rotor port, said first passage component and said second passage component intersecting at an apex portion of the first subterranean passage.

5. The rotor element according to claim 4, wherein
at least one of said first passage component and said second passage component is angled about 45° relative to the rotor face surface.

6. The rotor element according to claim 3, wherein
the diameter of the first subterranean passage is generally in the range of about 2.2 mm to about 0.12 mm.

7. The rotor element according to claim 3, wherein
the depth of said first subterranean passage is generally in the range of about ½ the height of the rotor body.

8. The rotor element according to claim 3, further including:
a patterned rotor channel formed in the rotor face of the rotor body wherein in the second position, at least a portion of the patterned rotor channel is in fluid communication with at least one of the first stator port and the second stator port.

9. A shear valve assembly comprising:
a stator element having a body, a stator face and at least a first stator passage and a second stator passage extending through the stator body, said first passage and said second passage terminating at the stator face at a respective first stator port and a respective second stator port; and
a rotor element having rotor body defining a rotor face configured for fluid-tight contact against said stator face at a rotor/stator interface, said rotor face defining a first rotor port and a spaced second rotor port, and said rotor body defining a first subterranean passage extending fully beneath said rotor face having one end terminating at the first rotor port at the rotor face surface, and having an opposite end terminating at the second rotor port at the rotor face, said rotor face and said stator face being rotatable about a rotation axis relative one another between:
a first position wherein said first subterranean passage fluidly couples the first stator port and the second stator port with the first rotor port and the second rotor port, enabling fluid flow between the first stator passage, through the first subterranean passage, and the second stator passage; and
a second position wherein said first subterranean passage is fluidly decoupled from at least one of the first stator port and the second stator port.

10. The shear valve assembly according to claim 9, wherein
said first subterranean passage is contained in a plane intersecting the rotor face surface.

11. The shear valve assembly according to claim 10, wherein
said plane containing the first subterranean passage is substantially perpendicular to an interface plane containing the rotor/stator interface.

12. The shear valve assembly according to claim 10, wherein
said first subterranean passage includes a substantially linear first passage component extending into the rotor body from the first rotor port, and a substantially linear second passage component extending into the body from the second rotor port, said first passage component and said second passage component intersecting at an apex portion of the first subterranean passage.

13. The shear valve assembly according to claim 11, wherein
at least one of said first passage component and said second passage component is angled about 45° relative to the rotor face surface.

14. The shear valve assembly according to claim 9, wherein
the depth of said first subterranean passage is generally in the range of about ½ the height of the rotor body.

15. The shear valve assembly according to claim 9, further including:
a patterned rotor channel formed in the rotor face of the rotor body wherein in the second position, at least a portion of the patterned rotor channel is in fluid communication with at least one of the first stator port and the second stator port.

16. The shear valve assembly according to claim 9, wherein
said stator element includes a third stator passage extending through the stator body, and terminating at the stator face at a respective third stator port;
said rotor face and said stator face further being rotatable about the rotation axis, relative one another, to a third position, wherein said first subterranean passage fluidly couples the third stator port and one of the first and second stator port with the first rotor port and the second rotor port, enabling fluid flow between the third stator passage, through the first subterranean passage, and through one of the first and second stator passage.

17. The shear valve assembly according to claim 16, further including:
a patterned rotor channel formed in the rotor face of the rotor body wherein in the second position, at least a portion of the patterned rotor channel is in fluid communication with at least two of the first stator port, the second stator port and the third stator port.

18. The shear valve assembly according to claim 17, wherein
the patterned rotor channel comprises three leg portions extending radially outward from the relative rotational axis thereof.

19. The shear valve assembly according to claim 18, wherein
one of said leg portions includes a restrictive section to reduce fluid flow therethrough relative to the two remaining leg portions.

20. The shear valve assembly according to claim 18, wherein
said stator element further includes a fifth stator passage extending through the stator body, and terminating at a fifth stator port in fluid communication with the patterned rotor channel when in the second position.

21. The shear valve assembly according to claim 9, wherein
said stator element includes a third stator passage extending through the stator body, and terminating at the stator face at a respective third stator port, and a fourth stator passage extending through the stator body, and terminating at the stator face at a respective fourth stator port, and
a rotor body further defining a third rotor port and a spaced fourth rotor port, and said rotor body defining a second subterranean passage extending fully beneath said rotor face having one end terminating at the third rotor port at the rotor face surface, and having an opposite end terminating at the fourth rotor port at the rotor face, wherein
in said first position, said second subterranean passage fluidly couples the third stator port and the fourth stator port with the third rotor port and the fourth rotor port, enabling fluid flow between the third stator passage, through the second subterranean passage, and the fourth stator passage; and
in the second position, said second subterranean passage is fluidly decoupled from at least one of the third stator port and the fourth stator port, and
said rotor face and said stator face further being rotatable about the rotation axis, relative one another, to a third position, wherein said first subterranean passage fluidly couples the first stator port and the third stator port with the first rotor port and the third rotor port, enabling fluid flow between the first stator passage, through the first subterranean passage, and the third stator passage; and
wherein said second subterranean passage fluidly couples the second stator port and the fourth stator port with the second rotor port and the fourth rotor port, enabling fluid flow between the second stator passage, through the second subterranean passage, and the fourth stator passage.

22. The shear valve assembly according to claim 21, wherein
said first subterranean passage is contained in a first plane intersecting the rotor face surface, and
said second subterranean passage is contained in a second plane also intersecting the rotor face surface.

23. The shear valve assembly according to claim 22, wherein
said first plane containing the first subterranean passage and said second plane containing the second subterranean passage are both oriented substantially perpendicular to an interface plane containing the rotor/stator interface.

24. The shear valve assembly according to claim 22, wherein
each said first subterranean passage and said second subterranean passage includes a substantially linear first passage component extending into the rotor body from the corresponding first rotor port and third rotor port, and a substantially linear second passage component extending into the body from the corresponding second rotor port and fourth rotor port, each said first passage component and each corresponding said second passage component intersecting at a respective apex portion of the corresponding first subterranean passage and second subterranean passage.

25. The shear valve assembly according to claim 24, wherein
at least one of each said first passage component and corresponding said second passage component is angled about 45° relative to the rotor face surface.

26. The shear valve assembly according to claim 21, further including:
a patterned rotor channel formed in the rotor face of the rotor body wherein in the second position, at least a portion of the patterned rotor channel is in fluid communication with at least two of the first stator port, the second stator port, the third stator port and the fourth stator port.

27. The shear valve assembly according to claim 26, wherein
the patterned rotor channel formed in the rotor face of the rotor body wherein in the second position, the patterned rotor channel is in fluid communication with the first stator port, the second stator port, the third stator port and the fourth stator port.

28. The shear valve assembly according to claim 18, wherein
said stator element further includes a fifth stator passage extending through the stator body, and terminating at a fifth stator port in fluid communication with the patterned rotor channel when in the second position.

29. A method of transferring liquid in a shear valve assembly comprising:
providing a shear valve assembly having stator element and a rotor element in relative rotational contact with the stator element, said stator element having a body with a stator face, said body defining a first stator passage and a second stator passage extending through the stator body, said first passage and said second passage terminating at the stator face at a respective first stator port and a respective second stator port, said rotor element having a rotor body defining a rotor face configured for fluid-tight contact against said stator face at a rotor/stator interface, said rotor face defining a first rotor port and a spaced second rotor port, and said rotor body defining a first subterranean passage extending fully beneath said rotor face having one end terminating at the first rotor port at the rotor face surface, and having an opposite end terminating at the second rotor port at the rotor face;
rotating said rotor face relative to said stator face about a rotation axis, while maintaining said fluid-tight seal, to a first position wherein said first rotor port is in fluid communication with said first stator port, and said second rotor port is in fluid communication with said second stator port; and
passing a liquid through the first stator passage, into the first subterranean passage, and out through the second stator passage.

30. The method according to claim 29, further including:
rotating said rotor face relative to said stator face to a second position wherein said first subterranean passage is fluidly decoupled from the first stator port and the second stator port.
